(19) United States
(12) Patent Application Publication
(10) Pub. No.: US 2026/0189667 A1
(43) Pub. Date: Jul. 2, 2026

(54) IMAGE PROCESSING APPARATUS, INFORMATION PROCESSING TERMINAL, AND INFORMATION PROCESSING METHOD

(71) Applicant: CANON KABUSHIKI KAISHA, Tokyo (JP)

(72) Inventor: HIROAKI KOBAYASHI, Kanagawa (JP)

(21) Appl. No.: 19/413,954

(22) Filed: Dec. 9, 2025

(30) Foreign Application Priority Data
Dec. 27, 2024 (JP) 2024-232990

(51) Int. Cl. H04N 1/44; H04N 1/00

(52) U.S. Cl. CPC H04N 1/4433; H04N 1/00408; H04N 1/4413; H04N 1/4486; H04N 1/00488

(57) ABSTRACT

An image processing apparatus includes at least one memory storing a program and at least one processor, that when executing the program, is caused to authenticate whether authentication information input for login to an information processing terminal matches set authentication information, receive an acquisition operation of acquiring the set authentication information, and output the set authentication information in a case where the acquisition operation is received.

### BACKGROUND

### Field of the Technology

The present disclosure relates to an image processing apparatus, an information processing terminal, and an information processing method.

### Description of the Related Art

An administrator authority for an information processing terminal is granted if a user is authenticated as an administrative user. Authentication is generally performed by inputting authentication information including a user name and a password. The authentication information is set to a default value at the time of shipment of the information processing terminal, and the value is often known as it is written in a manual or the like. Leaving authentication information at its default setting is a vulnerability, so it is recommended to reset it before use. Users however often forget to reset the authentication information.

Japanese Patent Application Laid-Open No. 2023-56815 describes a technique for storing authentication information in a server, requesting the server to acquire the authentication information from an information processing terminal, and performing authentication using the acquired authentication information.

According to the technique described in Japanese Patent Application Laid-Open No. 2023-56815, the authentication information acquired from the server is used as is, so that anyone who can display an authentication screen can be authenticated.

If this technique is used to authenticate a server function of an image processing apparatus equipped with a web server, even a person who does not know authentication information can be authenticated in a location physically distant from the image processing apparatus, which poses an issue of not being able to maintain the system's security.

### SUMMARY

According to an aspect of the present disclosure, an image processing apparatus includes at least one memory storing a program and at least one memory, that when executing the program, is caused to authenticate whether authentication information input for login to an information processing terminal matches set authentication information, receive an acquisition operation of acquiring the set authentication information, and output the set authentication information in a case where the acquisition operation is received.

Features of the present disclosure will become apparent from the following description of embodiments with reference to the attached drawings. The following description of embodiments is described by way of example.

### BRIEF DESCRIPTION OF THE DRAWINGS

FIG. 1 is an overall configuration diagram of an information processing system.

FIG. 2 is a hardware configuration diagram of an information processing terminal and an image processing apparatus.

FIG. 3 is a software configuration diagram of the information processing terminal and the image processing apparatus.

FIGS. 4A and 4B illustrate examples of setting screens displayed by the information processing terminal.

FIGS. 5A to 5E illustrate examples of setting screens displayed by the information processing terminal.

FIG. 6 is a flowchart illustrating browser processing by the information processing terminal.

FIGS. 7A to 7C illustrate examples of authentication information stored in the information processing terminal.

FIG. 8 is a flowchart illustrating processing for displaying a screen by the image processing apparatus.

FIGS. 9A to 9C illustrate examples of screens displayed by the image processing apparatus.

FIG. 10 is a flowchart illustrating browser processing of the information processing terminal.

FIG. 11 is a flowchart illustrating processing for displaying a screen by the image processing apparatus.

FIG. 12 illustrates an example of data to be printed by the image processing apparatus.

FIG. 13 is a flowchart illustrating processing for displaying a screen by the image processing apparatus.

### DESCRIPTION OF THE EMBODIMENTS

Embodiments for implementing the present disclosure will be described below with reference to the drawings. Components described in the following embodiments are merely examples and are not intended to limit the scope of the present disclosure.

### (First Embodiment)

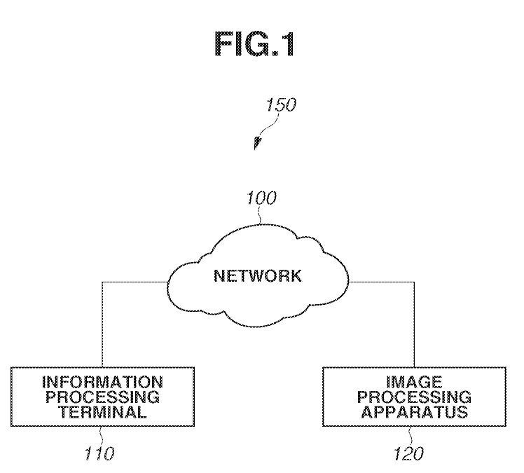

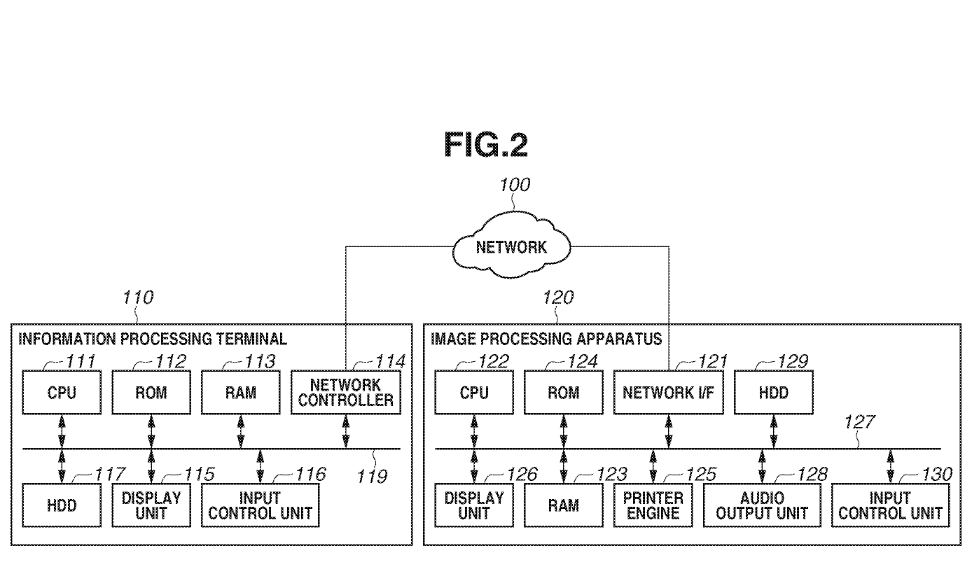

FIG. 1 illustrates an example of an overall configuration of an information processing system 150 according to a first embodiment. According to the present embodiment, an example is described in which the above-described issue is addressed by displaying authentication information on a display unit 126 (FIG. 2) of an image processing apparatus 120.

In the information processing system 150, an information processing terminal 110 and the image processing apparatus 120 are connected to each other via a network 100. While the present description refers to a single information processing terminal 110 and a single image processing apparatus 120, a plurality of information processing terminals 110 and image processing apparatuses 120 may exist on the network 100.

The network 100 is a standard network connection and may take the form of the Internet or an intranet. Any connection form can be used as a connection method as long as both the information processing terminal 110 and the image processing apparatus 120 are connected to the network 100.

A hardware configuration of the information processing terminal 110 and the image processing apparatus 120 according to the present embodiment will be described with reference to FIG. 2.

The information processing terminal 110 includes a central processing unit (CPU) 111, a read-only memory (ROM) 112, a random access memory (RAM) 113, a network controller 114, a display unit 115, an input control unit 116, a hard disk drive (HDD) 117, and a system bus 119.

The information processing terminal 110 can perform wireless communication or wired communication using the network controller 114. Each component in the hardware of the information processing terminal 110 is connected to the system bus 119.

The ROM 112 is a nonvolatile storage device and stores various operation mode settings and the like that need to be retained even after the information processing terminal 110 is restarted. The information stored in the ROM 112 is processed by the CPU 111.

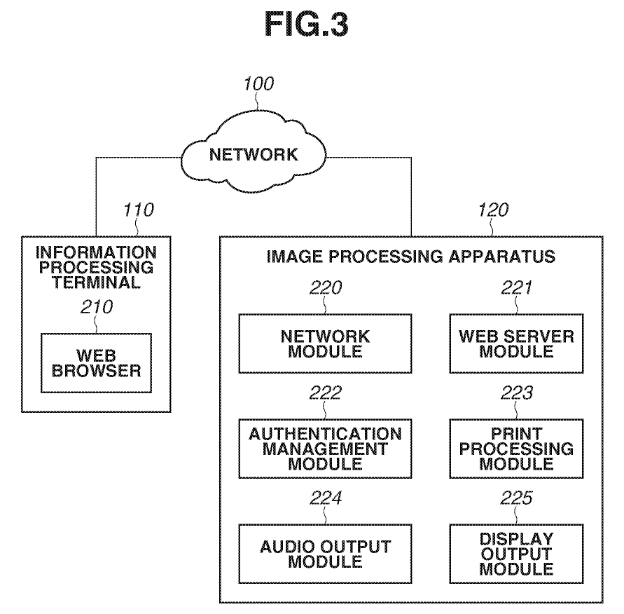

The HDD 117 stores various types of data in the information processing terminal 110, including an operating system (OS) and various applications. The CPU 111 executes processing based on a program stored in the HDD 117, thereby realizing a software configuration of the information processing terminal 110 illustrated in FIG. 3 and processing in each step in the flowcharts described below.

The RAM 113 is a work memory area for executing a program.

The network controller 114 controls communication in the network 100 and uses Wireless Fidelity (Wi-Fi®), wired local area network (LAN) connection, and the like for communication.

The display unit 115 controls information to be output to a screen of the information processing terminal 110.

The input control unit 116 controls information instructed by a user via a keyboard or the like connected to the information processing terminal 110.

An application of the information processing terminal 110 uses the display unit 115 and the input control unit 116 to provide a user with network communication information and various information of the information processing terminal 110.

The image processing apparatus 120 includes a network interface (I/F) 121, a CPU 122, a RAM 123, a ROM 124, a printer engine 125, the display unit 126, a system bus 127, an audio output unit 128, an HDD 129, and an input control unit 130.

The network I/F 121 is used to connect to the information processing terminal 110 via the network 100. The image processing apparatus 120 can perform processing for communicating with the information processing terminal 110 via the network I/F 121 and is configured to notify the information processing terminal 110 of the information within the image processing apparatus 120.

The CPU 122 realizes printing by outputting an image signal as output information to the printer engine 125 connected to the system bus 127 based on a control program stored in the ROM 124. The CPU 122 executes processing based on an application program and the like stored in the ROM 124 and the HDD 129.

The RAM 123 functions as a main memory, a work area, and the like of the CPU 122. The RAM 123 is used to execute a control program, as an output information expansion area, as an environmental data storage area, and the like.

The ROM 124 stores a control program of the CPU 122, font data used for generating the above-described output information, information used in the image processing apparatus 120, and the like.

The printer engine 125 outputs (prints) an image signal as output information on paper.

The display unit 126 controls information to be output to a screen of the image processing apparatus 120.

The input control unit 130 controls information instructed by a user via an input device connected to the image processing apparatus 120. In a case where the screen is a pressure-sensitive panel, coordinates of a touch by a user are transmitted to the input control unit 130. Examples of input devices other than a pressure-sensitive panel include a keyboard and a mouse, and the input device used by a user and the image processing apparatus 120 may be connected via a wired connection or wirelessly using a technique such as Bluetooth® Low Energy.

The audio output unit 128 outputs audio from a speaker based on audio data.

The HDD 129 stores various types of data in the image processing apparatus 120, including the OS and various applications.

The system bus 127 connects each device. The CPU 122 executes processing based on a program stored in the ROM 124 or the HDD 129, thereby realizing a software configuration of the image processing apparatus 120 illustrated in FIG. 3 and processing in each step of the flowcharts described below.

FIG. 3 is a block diagram illustrating the software configurations of the information processing terminal 110 and the image processing apparatus 120 according to the present embodiment.

The information processing terminal 110 includes a web browser 210.

The web browser 210 is a program module that exists as a file stored in the HDD 117. The web browser 210 is loaded into the RAM 113 and executed by the OS or a module that uses the web browser 210 when executed.

Processing described in the present embodiment is realized by the CPU 111 reading out an application and a program of each module (software) stored in the HDD 117 into the RAM 113 as needed and executing it.

The web browser 210 receives HyperText Markup Language (HTML) and JavaScript® from a web server module 221 via a network module 220 of the image processing apparatus 120 and performs display on the display unit 115 based on the received data.

The image processing apparatus 120 includes a network module 220, a web server module 221, an authentication management module 222, a print processing module 223, an audio output module 224, and a display output module 225.

The network module 220 performs communication between the image processing apparatus 120 and the information processing terminal 110 and provides a function of communicating with an external device using a protocol, such as Hypertext Transfer Protocol (HTTP), a Simple Network Management Protocol (SNMP), or the like.

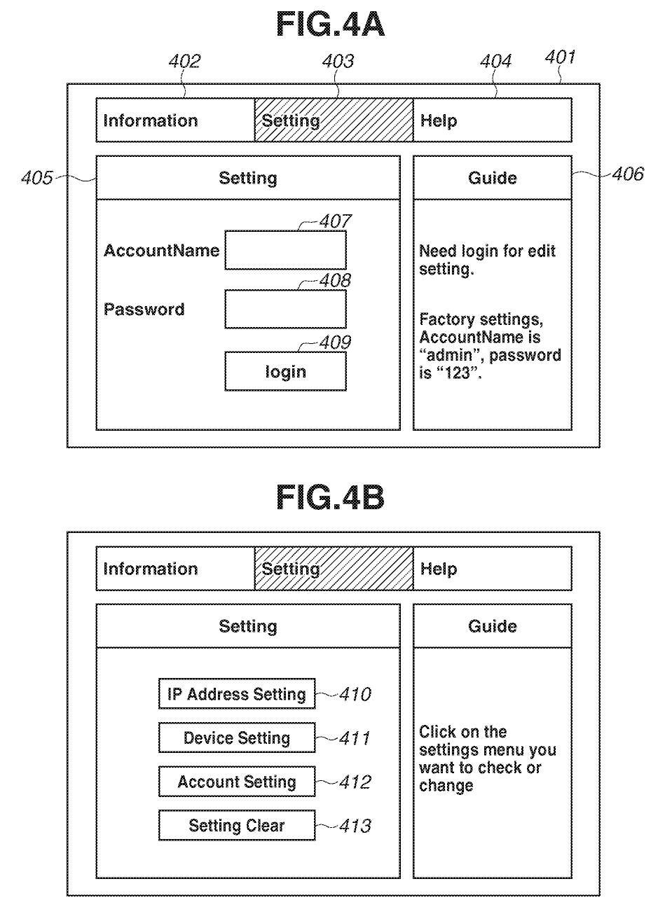

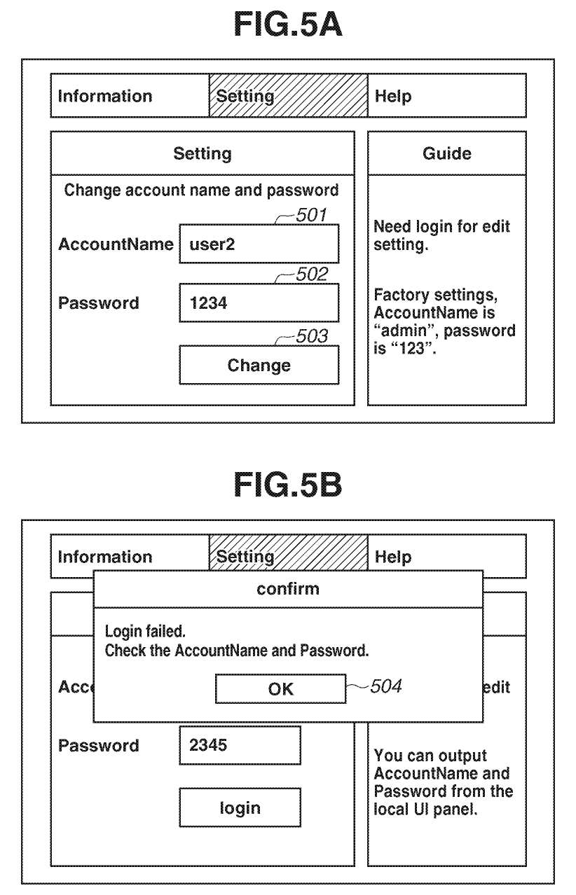

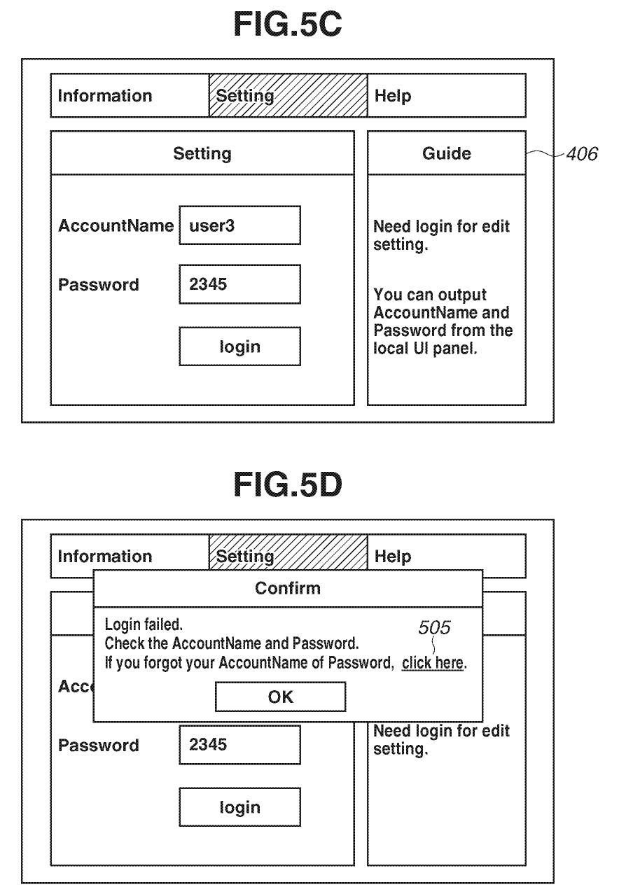

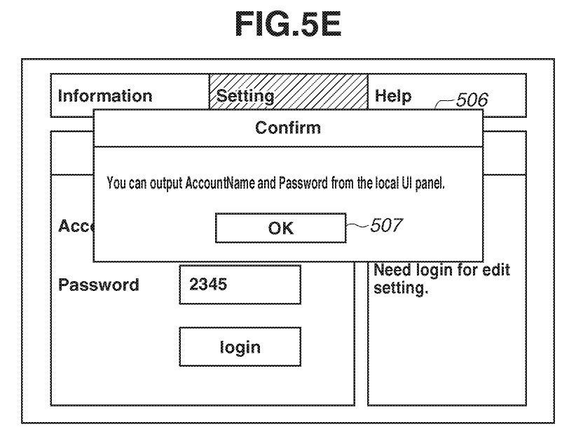

The web server module 221 provides a screen in HTML and JavaScript®, and receives a request for acquiring the screen via the network module 220. Examples of screens are described below with reference to FIGS. 4A, 4B, and 5A to 5E. The web server module 221 also provides a function of performing various settings of the image processing apparatus 120 via these screens.

The authentication management module 222 authenticates a user who can use the function of performing various settings provided by the web server module 221. The authentication management module 222 also has a function of updating information (account name and password) used for authentication.

The print processing module 223 transmits drawing data to be output by the printer engine 125 to the printer engine 125.

The audio output module 224 transmits audio data to be output by the audio output unit 128 to the audio output unit 128.

The display output module 225 transmits screen data to be output and displayed on the display unit 126 to the display unit 126.

FIG. 4A illustrates an example of a screen 401 displayed by the information processing terminal 110. The screen 401 is displayed on the display unit 115 by the web browser 210 of the information processing terminal 110 receiving and interpreting the HTML and JavaScript® from the web server module 221 of the image processing apparatus 120.

FIG. 4A illustrates operation menus 402, 403, and 404 of the information processing terminal 110.

In the example in FIG. 4A, the operation menu 403 is selected, and details of the operation menu 403 are displayed in a detail area 405 in a lower part of the screen 401. The detail area 405 is an area that displays a screen for setting various setting items for managing the device. However, enabling anyone to perform these settings leads to risks of information leakage, etc., so authentication is required before performing a setting operation.

The detail area 405 in FIG. 4A includes a user name input field 407, a password input field 408 for inputting the authentication information, and a login button 409 for executing authentication. A guide area 406 displays operation instructions and tips.

The guide area 406 is always displayed together with the detail area 405 that displays options and input fields for a user to operate, so the user can easily recognize the operation instructions and tips. Default authentication information is typically set in the image processing apparatus 120 at the time the image processing apparatus 120 is shipped from the manufacturer or when the image processing apparatus 120 is reset. The authentication information is typically described in a product manual or the like.

In some instances, users may inquire with a customer center of the manufacturer of the image processing apparatus 120 without checking the manual. This can be burdensome for the manufacturer. To prevent such burden, some products always display the default authentication information in the guide area 406.

For example, as illustrated in FIG. 4A, the guide area 406 always displays that the default user name is "admin" and the password is "123".

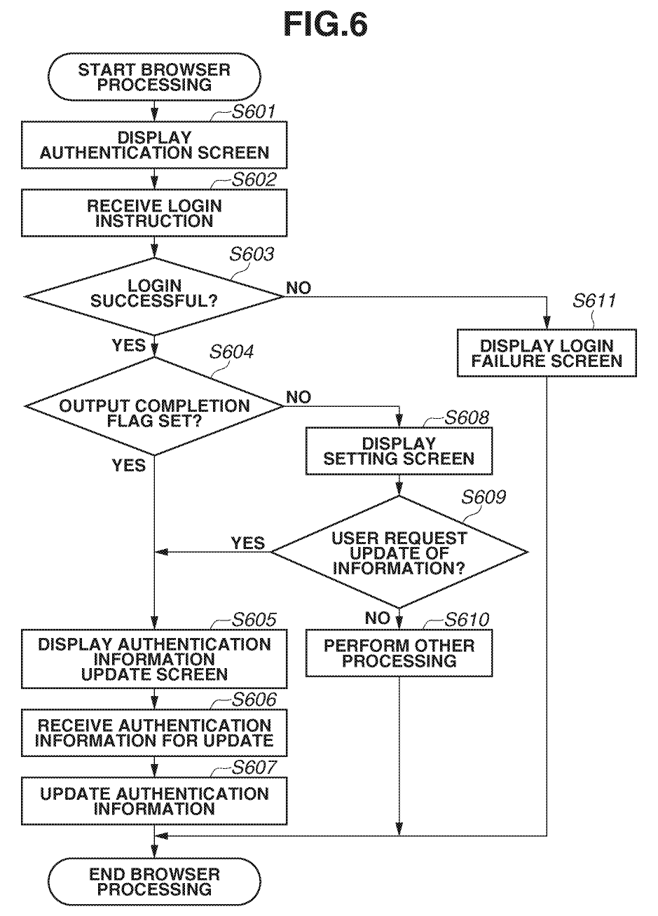

FIG. 6 illustrates a processing flow related to an operation on a screen displayed on the screen 401 illustrated in FIG. 4A. The processing is started if the CPU 111 detects that a user presses the operation menu 403.

In step S601, the CPU 111 displays an authentication screen The authentication screen displayed in S601 is the detail area 405 illustrated in FIG. 4A.

In step S602, the CPU 111 receives a login instruction from the user For example, the CPU 111 detects that the login button 409 is pressed by the user.

If the login button 409 is pressed, the CPU 111 transmits a user name input in the user name input field 407 and a password input in the password input field 408 to the image processing apparatus 120 (transmits a login request). The user name and password are examples of the authentication information.

In step S603, the CPU 111 determines whether the login is successful. More specifically, the CPU 111 transmits the login request to the authentication management module 222 of the image processing apparatus 120 and receives the result.

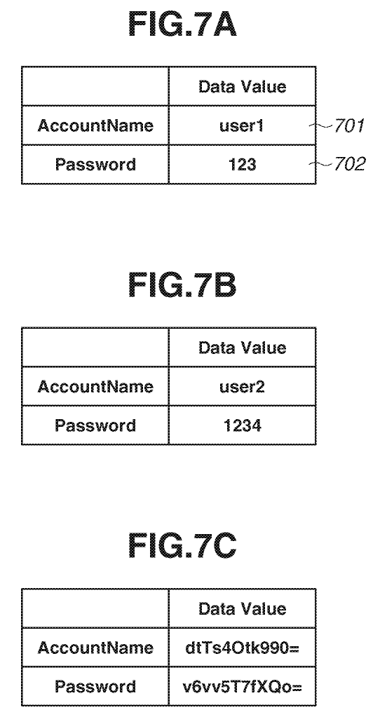

In a case where the received result indicates that the login is successful (YES in step S603), the processing proceeds to step S604. If the login fails (NO in step S603), the processing proceeds to step S611. The authentication management module 222 determines whether the login is successful based on whether the values input in the user name input field 407 and the password input field 408 match the authentication information in a database illustrated in FIG. 7A. In a case where the value input in the user name input field 407 matches a user name 701 (also referred to as authentication information 701) in the database and the value input in the password input field 408 matches a password 702 (also referred to as authentication information 702) in the database, the authentication management module 222 determines that the login is successful. In a case where the input values of the user name and password do not match the values in the database, the authentication management module 222 determines that the login has failed.

The database illustrated in FIG. 7A is stored in the HDD 129 and remains even if the image processing apparatus 120 is powered off.

Turning back to FIG. 6, in step S604, the CPU 111 determines whether the authentication information has ever been output (displayed) on the display unit 126 of the image processing apparatus 120. More specifically, the CPU 111 transmits a request to the authentication management module 222 of the image processing apparatus 120 to check a status of an output completion flag and receives the result.

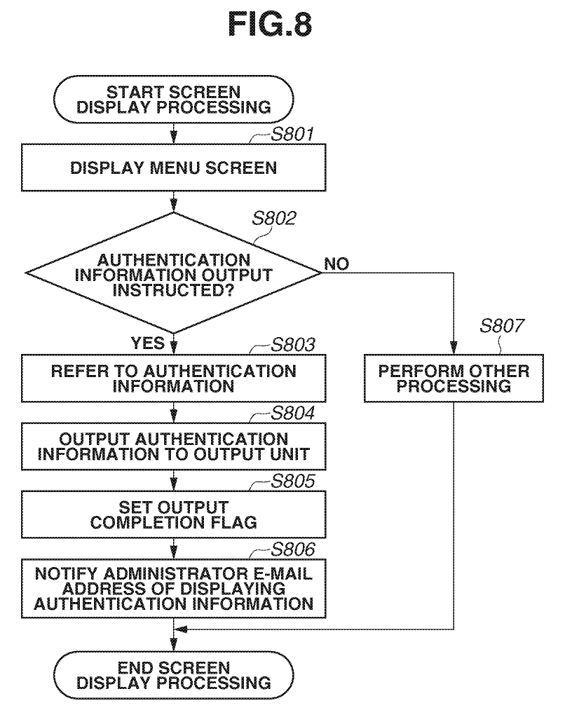

The output completion flag is stored in the HDD 129 in step S805 in FIG. 8, which is described below. If the output completion flag is set, the authentication information has been output. Since security is enhanced by changing the authentication information previously output, in a case where the output completion flag is set, control is performed to update the authentication information in step S605 and the subsequent steps. If the received output completion flag is set (YES in step S604), the processing proceeds to step S605. If the received output completion flag is not set (NO in step S604), the processing proceeds to step S608.

In step S605, the CPU 111 displays an authentication information update screen. FIG. 5A illustrates an example of the authentication information update screen displayed by the information processing terminal 110. An update user name input field 501 receives input of an updated user name. An update password input field 502 receives input of an updated password. An authentication information update button 503 is used to instruct execution of processing for updating the authentication information stored in the database with the contents input in the update user name input field 501 and the update password input field 502.

The CPU 111 receives input of the user name and password that are newly input in the update user name input field 501 and the update password input field 502, respectively, for updating. The user name and password are examples of the authentication information.

Turning back to FIG. 6, in step S606, the CPU 111 detects that the user presses the authentication information update button 503.

In step S607, the CPU 111 transmits a request to the authentication management module 222 of the image processing apparatus 120 to update the authentication information items 701 and 702 in the database illustrated in FIG. 7A with the values input in the update user name input field 501 and the update password input field 502. The processing then terminates. The request includes the user name input in the update user name input field 501 and the password input in the update password input field 502. If the authentication management module 222 receives the request to update the authentication information, it stores the authentication information in the database in the HDD 129. The authentication information is stored as plain text.

FIG. 7B illustrates the database after the authentication information is updated with the contents illustrated in FIG. 5A. Since the authentication information is updated, the output completion flag is cleared in the HDD 129. The authentication management module 222 updates the authentication information items 701 and 702 set in the database in FIG. 7A with the new authentication information in FIG. 7B input by the information processing terminal 110.

This enables a user to freely change the authentication information in the present system. However, there is a possibility that the user may forget the changed authentication information. In such a case, it is possible to clear the authentication information using a setting clear button 413 illustrated in FIG. 4B described below. Doing so will result in all of the other settings in the image processing apparatus 120 to be reset back to factory values. Thus, if the authentication information is cleared, it is necessary to re-set all the settings.

Therefore, a method for confirming the authentication information without clearing the settings is described in FIG. 8 and subsequent drawings.

Returning to FIG. 6, in step S608, the CPU 111 displays a setting screen. FIG. 4B illustrates an example of the setting screen. The setting screen includes an Internet Protocol (IP) address setting button 410 for transitioning to an IP address setting screen (not illustrated). The setting screen also includes a device setting button 411 for transitioning to a device setting screen (not illustrated) for setting a sleep time of the image processing apparatus 120.

The setting screen also includes an account setting button 412 for transitioning to a user authentication information update screen (FIG. 5A). The setting screen also includes a setting clear button 413 for clearing the settings and account settings to the settings at the time of shipment from the manufacturer.

Turning back to FIG. 6, in step S609, the CPU 111 determines whether the user has pressed the authentication information setting button 412. In a case where the authentication information setting button 412 is pressed (YES in step S609), the processing proceeds to step S605. If any other button is pressed (NO in step S609), the processing proceeds to step S610.

In step S610, the CPU 111 performs processing corresponding to the button pressed in step S609, and then terminates the processing.

In step S611, the CPU 111 displays a login failure screen, and then terminates the processing. FIG. 5B illustrates an example of the login failure screen. If an OK button 504 is pressed, a pop-up window is closed. FIG. 5C illustrates a screen after the pop-up window is closed. As illustrated in the guide area 406 in FIG. 5C, a message indicating that the authentication information can be confirmed may be displayed on the display unit 126.

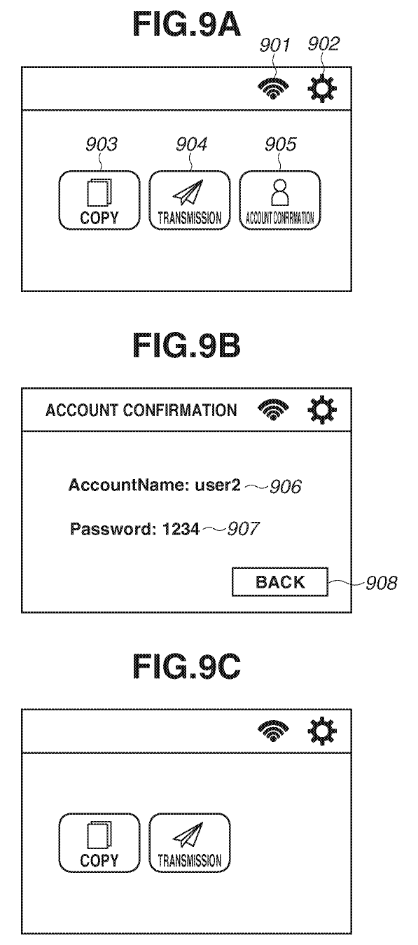

The image processing apparatus 120 controls the information processing terminal 110 to display an operation method for acquiring the authentication information items 701 and 702 set in the database in FIG. 7A in the guide area 406 in FIG. 5C. In response to the instruction from the image processing apparatus 120, the information processing terminal 110 performs control to display the operation method for the image processing apparatus 120 to acquire the authentication information items 701 and 702 set in the database in FIG. 7A. The operation of acquiring the authentication information items 701 and 702 is, for example, a pressing operation on an account confirmation button 905 in FIG. 9A described below.

FIG. 8 illustrates a processing flow for displaying a screen by the image processing apparatus 120. The processing in the present flowchart is started if a user operates the display unit 126 using the input control unit 130.

In step S801, the CPU 122 displays a menu screen on the display unit 126 via the display output module 225. FIG. 9A illustrates an example of the menu screen. The menu screen in FIG. 9A includes a communication setting button 901, a device setting button 902, a copy button 903, a transmission button 904, and the account confirmation button 905.

In a case where the communication setting button 901 is pressed, the CPU 122 displays a setting screen (not illustrated) related to communication on the display unit 126. In a case where the device setting button 902 is pressed, the CPU 122 displays the device setting screen (not illustrated) for setting the sleep time of the main body and the like.

In a case where the copy button 903 is pressed, the CPU 122 displays a copy application screen (not illustrated) for executing copying. In a case where the transmission button 904 is pressed, the CPU 122 displays a transmission application screen (not illustrated) for transmitting data generated by scanning to an e-mail address or a file server.

In a case where the account confirmation button 905 is pressed, the CPU 122 displays an account confirmation screen (FIG. 9B) for outputting the authentication information items 701 and 702 in the database illustrated in FIGS. 7A to 7C. Details regarding the account confirmation screen are described below.

The screens illustrated in FIGS. 9A to 9C are provided only to the display unit 126 by the display output module 225, are not provided by the web server module 221, and cannot be displayed on an external device such as the information processing terminal 110.

In step S802, the CPU 122 determines whether the user presses the account confirmation button 905. The CPU 122 receives an operation of acquiring the authentication information items 701 and 702 set in the database illustrated in FIGS. 7A to 7C via the input control unit (input device) 130 without authenticating the authentication information. The operation of acquiring the authentication information items 701 and 702 is, for example, a pressing operation on the account confirmation button 905.

If the account confirmation button 905 is pressed (YES in step S802), the processing proceeds to step S803. If any other operation is performed (NO in step S802), the processing proceeds to step S807.

In step S803, the CPU 122 refers to the authentication information items 701 and 702 in the database illustrated in FIGS. 7A to 7C.

In step S804, the CPU 122 outputs (displays) the account confirmation screen (FIG. 9B) on the display unit 126 via the display output module 225. In FIG. 9B, a user name display area 906, a password display area 907, and a back button 908 are displayed.

According to the present embodiment, the CPU 122 stores the authentication information in plain text, and thus displays the authentication information items 701 and 702 referred to in step S803 as they are in the user name display area 906 and the password display area 907. If the back button 908 is pressed, the display returns to the menu screen. By inputting character strings displayed in the user name display area 906 and the password display area 907 as they are to the user name input field 407 and the password input field 408 in the detail area 405, authentication will be successful.

Returning to FIG. 8, in step S805, the CPU 122 sets the output completion flag in association with the authentication information such as the user name and password displayed on the display unit 126 in step S804 and stores the output completion flag in the HDD 129.

In step S806, the CPU 122 transmits (notifies) an e-mail stating that the authentication information has been output to an e-mail address registered as an administrator. It is assumed that the e-mail address of the administrator can be set on the device setting screen (not illustrated), which opens after the device setting button 411 is pressed, or the device setting screen (not illustrated), which opens after the device setting button 902 is pressed, and is stored in the HDD 129.

In step S807, the CPU 122 performs processing corresponding to the button pressed in step S802. The processing then terminates. The processing in step S807 is not directly related to the present embodiment, so the description thereof is omitted.

As described above, according to the present embodiment, even if a user forgets the authentication information used to log into the web server of the image processing apparatus 120, the authentication information is displayed on the display unit 126 of the image processing apparatus 120 based on an instruction from the input control unit 130 of the image processing apparatus 120.

Accordingly, it is possible to easily confirm the authentication information while maintaining security.

### (Second Embodiment)

According to the first embodiment, a method for displaying authentication information on the display unit 126 of the image processing apparatus 120 is described. Also, according to the first embodiment, a method for storing authentication information in plain text so that the authentication information can always be confirmed is described.

A second embodiment is directed to describing a method in which authentication information is output by printing rather than being displayed on the display unit 126 of the image processing apparatus 120. A method for encrypting and handling the authentication information is also described. In addition, a method for enabling a user to confirm the authentication information only in a case where the user forgets the authentication information is described.

Descriptions for drawings similar to those according to the first embodiment are omitted herein.

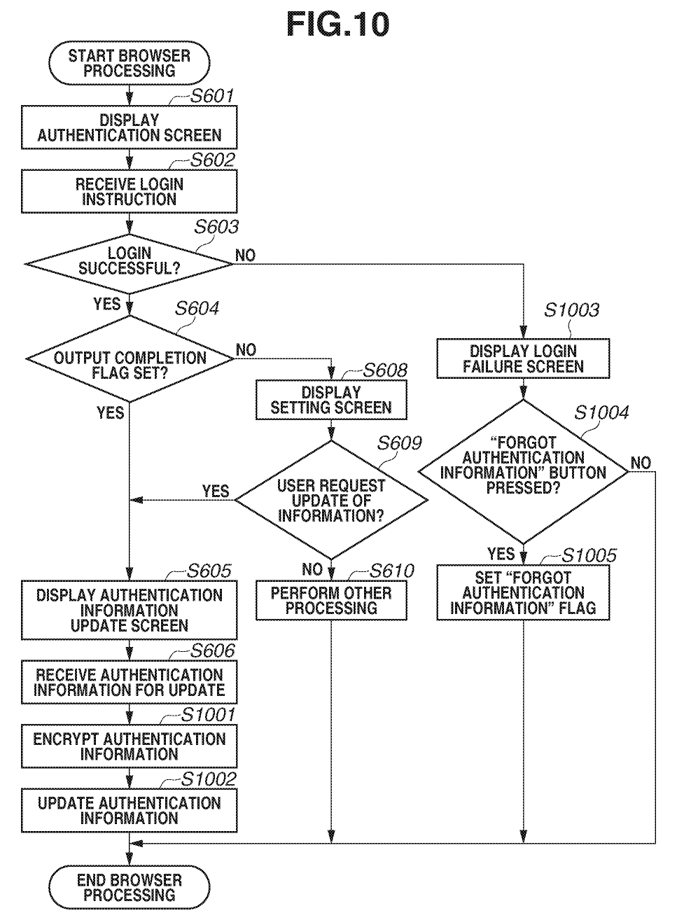

FIG. 10 illustrates a processing flow related to an operation on a screen displayed on the screen 401 illustrated in FIG. 4A. The processing in the present flowchart is started if a user presses the operation menu 403.

Processing in steps S601 to S606 and S608 to S610 is similar to that in FIG. 6, as such, descriptions thereof are omitted herein.

After the processing in step S606, in step S1001, the CPU 111 transmits a request to the authentication management module 222 of the image processing apparatus 120 to encrypt the new authentication information input in the update user name input field 501 and the update password input field 502 in FIG. 5A.

Upon receiving the request to encrypt the authentication information, the authentication management module 222 encrypts the received authentication information and stores it in the RAM 123. According to the present embodiment, encryption is performed using a Data Encryption Standard (DES) encryption method, and key information used for encryption is stored in the ROM 124 in advance.

According to the present embodiment, the key information stored in advance is used, but key information may be generated each time encryption is performed and stored in the HDD 129. While the present embodiment uses DES as the encryption method, other encryption methods may also be used.

In step S1002, the CPU 111 transmits an authentication information update request to the authentication management module 222 of the image processing apparatus 120 to update the authentication information in the database in FIG. 7A with the contents stored in the RAM 123 in step S1001. The processing then terminates. Upon receiving the authentication information update request, the authentication management module 222 stores the encrypted authentication information in the database in the HDD 129. FIG. 7C illustrates the database after the authentication information is updated with the contents in FIG. 5A.

In step S603, if login fails (NO in step S603), the processing proceeds to step S1003.

In step S1003, the CPU 111 displays the login failure screen. FIG. 5D illustrates an example of the login failure screen.

In step S1004, the CPU 111 determines whether a "forgot authentication information" button 505 on the login failure screen (FIG. 5D) is pressed. An operation of pressing the "forgot authentication information" button 505 is an example of an operation performed in the information processing terminal 110 if a user forgets the authentication information.

In a case where the "forgot authentication information" button 505 is pressed (YES in step S1004), the processing proceeds to step S1005. If the “forgot authentication information” button 505 is not pressed (NO in step S1004), the processing terminates.

In step S1005, the CPU 111 displays an operation explanation screen 506 in FIG. 5E.

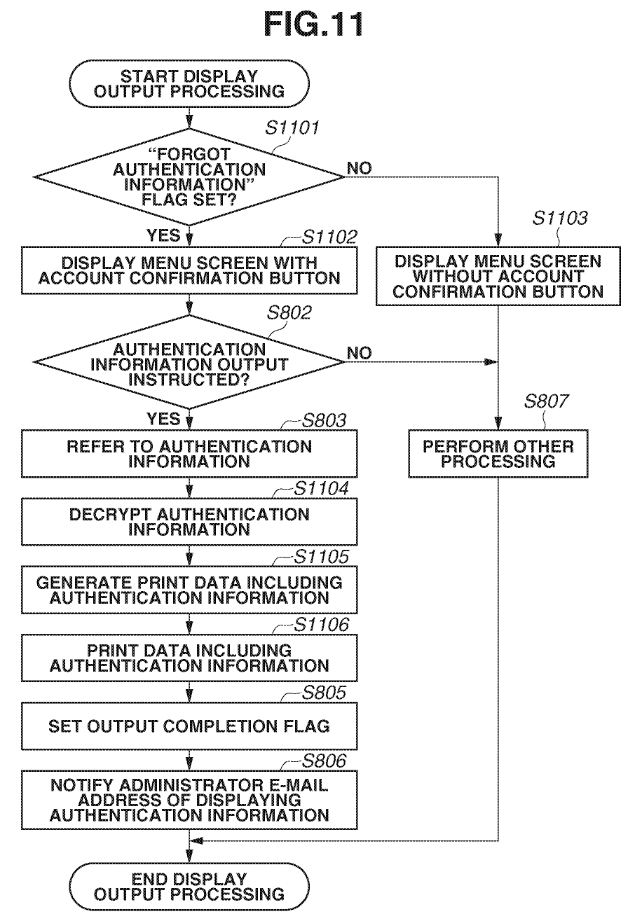

The operation explanation screen 506 includes an OK button 507 and displays a method for an operation of acquiring (printing) the authentication information items 701 and 702 set in the database in FIG. 7A. The operation of acquiring (printing) the authentication information items 701 and 702 is, for example, a pressing operation on the account confirmation button 905 in FIG. 9A. If the OK button 507 is pressed, the CPU 111 transmits a request to the authentication management module 222 of the image processing apparatus 120 to set a "forgot authentication information" flag, and the processing terminates. Upon receiving the request, the authentication management module 222 sets the "forgot authentication information" flag and stores it in the HDD 129. The "forgot authentication information" flag set in the present embodiment is referred to in a flowchart in FIG. 11.

FIG. 11 illustrates, a processing flow related to an operation on a screen displayed on the display unit 126 of the image processing apparatus 120. The processing in the present flowchart is started if a user operates the display unit 126 using the input control unit 130. Processing in steps S802, S803, and S805 to S807 are similar to those in FIG. 8 so descriptions thereof are omitted herein.

In step S1101, the CPU 122 determines whether the "forgot authentication information" flag processed in step S1005 in FIG. 10 is set. In a case where the "forgot authentication information" flag is set (YES in step S1101), the processing proceeds to step S1102. If the “forgot authentication information” flag is not set (NO in step S1101), the processing proceeds to step S1103.

In step S1102, the CPU 122 displays the menu screen (FIG. 9A) on the display unit 126. The menu screen (FIG. 9A) includes the account confirmation button 905. The CPU 122 can receive an operation of pressing the account confirmation button 905 on the menu screen (FIG. 9A).

In step S1103, the CPU 122 displays the menu screen (FIG. 9C) on the display unit 126. FIG. 9C illustrates a screen in which the account confirmation button 905 in FIG. 9A is omitted. The CPU 122 cannot receive the operation of pressing the account confirmation button 905 on the menu screen (FIG. 9C).

In step S1104, the CPU 122 decrypts the encrypted authentication information read from the HDD 129 in step S803. The key information is read from the ROM 124 and used in the same way as when the key information is encrypted.

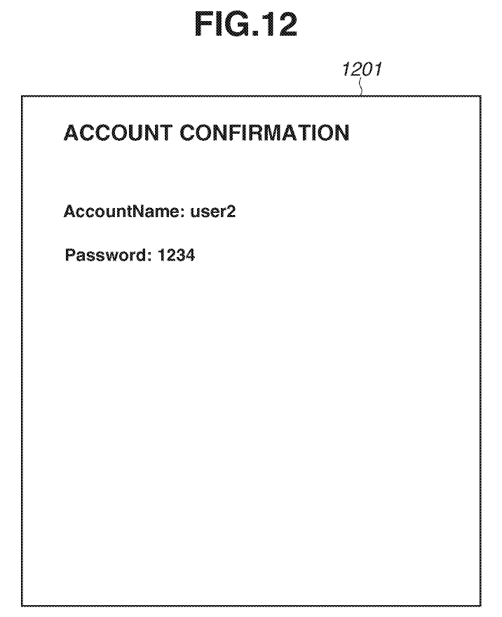

In step S1105, the CPU 122 generates Portable Document Format (PDF) data including the authentication information decrypted in step S1104. According to the present embodiment, PDF is used, but other formats such as Extensible Markup Language (XML) Paper Specification (XPS) may be used as long as it is printable print data. FIG. 12 illustrates an example of PDF data 1201. The PDF data 1201 includes the user name 701 and the password 702, which are the authentication information.

In step S1106, the CPU 122 outputs the PDF data generated in step S1105 using the print processing module 223 to the printer engine 125 and outputs paper on which the authentication information is printed. By inputting character strings included in the PDF data 1201 as they are to the user name input field 407 and the password input field 408 in the detail area 405, authentication will be successful.

As described above, according to the present embodiment, the authentication information is stored in the HDD 129 in the encrypted state so that security is enhanced more than that in the first embodiment. Even if a user forgets the authentication information used to log into the web server of the image processing apparatus 120, the authentication information is printed based on an instruction from the input control unit 130 of the image processing apparatus 120. Accordingly, it is possible to easily confirm the authentication information while maintaining security. The account confirmation button 905 is displayed only in a case where the "forgot authentication information" button 505 is pressed, enabling displaying an authentication information confirmation unit only in a case where it can be clearly determined that a user has forgotten the authentication information. Thus security can be enhanced.

### (Third Embodiment)

According to the first embodiment, a method for displaying authentication information on the display unit 126 of the image processing apparatus 120 is described. According to the second embodiment, a method for printing authentication information is described. According to a third embodiment, a method for outputting authentication information by audio will be described.

Descriptions of drawings similar to those according to the first embodiment are omitted herein.

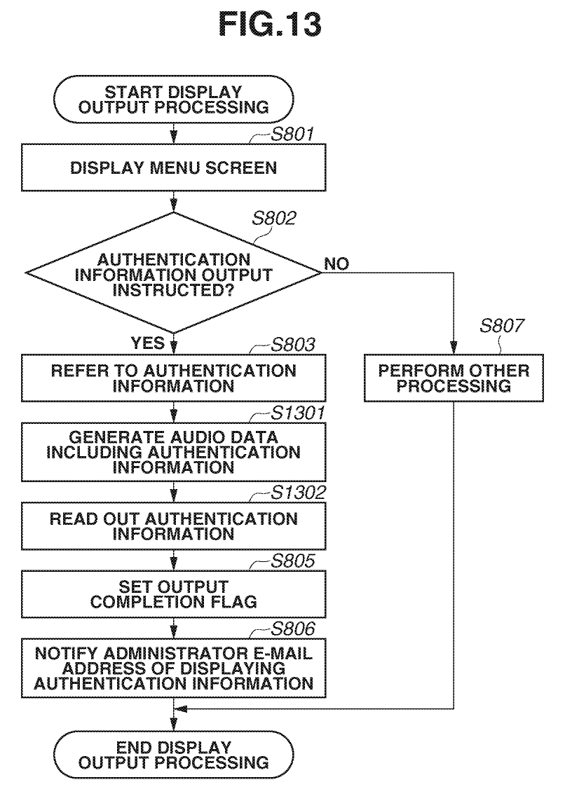

FIG. 13 illustrates a processing flow related to an operation on a screen displayed on the display unit 126 of the image processing apparatus 120. The processing in the present flowchart is started if the CPU 122 detects that a user operates the input control unit 130. Processing in steps S801 to S803 and S805 to S807 are similar to those in FIG. 8, so descriptions thereof are omitted herein.

In step S1301, the CPU 122 generates audio data including the authentication information items 701 and 702 read from the HDD 129 in step S803.

In step S1302, the CPU 122 outputs the audio data generated in step S1301 to the audio output unit 128 via the audio output module 224. By inputting character strings read out from the audio output module 224 as they are to the user name input field 407 and the password input field 408 in the detail area 405, authentication will be successful.

As described above, according to the present embodiment, even if a user forgets the authentication information used to log into the web server of the image processing apparatus 120, the authentication information is output in audio by the audio output unit 128 of the image processing apparatus 120 based on an instruction from the input control unit 130 of the image processing apparatus 120. Accordingly, it is possible to easily confirm the authentication information while maintaining security.

According to the above-described first to third embodiments, even if a user forgets authentication information to be used for authentication of the image processing apparatus 120, it is possible to easily confirm the authentication information while maintaining security, thereby improving user convenience.

The present disclosure can also be realized by processing of supplying a program for implementing one or more functions of the above-described embodiments to a system or an apparatus via a network or a storage medium and having one or more processors in a computer of the system or the apparatus read and execute the program. In addition, the present disclosure can also be realized by a circuit (e.g., an application specific integrated circuit (ASIC)) that realizes one or more functions.

The above-described embodiments are merely examples for implementing the present disclosure, so that the examples should not be construed restrictively limiting the technical scope of the present disclosure. In other words, the present disclosure can be implemented in the various forms without departing from the technical idea and/or the main features thereof.

According to the present disclosure, even if a user forgets authentication information set to an image processing apparatus, it is possible to easily confirm the authentication information while maintaining security.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-232990, filed December 27, 2024, which is hereby incorporated by reference herein in its entirety.

What is claimed is:

1. An image processing apparatus comprising:
at least one memory storing a program; and
at least one processor, that when executing the program, is caused to:
authenticate whether authentication information input for login to an information processing terminal matches set authentication information,
receive an acquisition operation of acquiring the set authentication information, and
output the set authentication information in a case where the acquisition operation is received.

2. The image processing apparatus according to claim 1, wherein the at least one processor is further caused to update the set authentication information with new authentication information input by the information processing terminal.

3. The image processing apparatus according to claim 2,
wherein the at least one processor is further caused to encrypt and store the new authentication information, and decrypt and output the encrypted authentication information.

4. The image processing apparatus according to claim 2, wherein, in a case where the set authentication information is outputted and then the input authentication information is authenticated, the set authentication information is updated with the new authentication information input by the information processing terminal.

5. The image processing apparatus according to claim 1, wherein the at least one processor is further caused to, in a case where the input authentication information is not authenticated, control the information processing terminal to display a method for performing an operation of acquiring the set authentication information.

6. The image processing apparatus according to claim 1, wherein the at least one processor is further caused to receive an operation of acquiring the set authentication information without authenticating the authentication information.

7. The image processing apparatus according to claim 1, wherein the at least one processor is further configured to receive an operation of acquiring the set authentication information in a case where the input authentication information is not authenticated and not receive an operation of acquiring the set authentication information in a case where the input authentication information is authenticated.

8. The image processing apparatus according to claim 7, wherein the at least one processor is further caused to receive an operation of acquiring the set authentication information in a case where the input authentication information is not authenticated and the authentication is performed on the information processing terminal, and does not receive an operation of acquiring the set authentication information in a case where the input authentication information is not authenticated the authentication is not performed on the information processing terminal.

9. The image processing apparatus according to claim 1, wherein the at least one processor is further caused to output the set authentication information to a display.

10. The image processing apparatus according to claim 1, wherein the at least one processor is further caused to output the set authentication information to a printer engine.

11. The image processing apparatus according to claim 1, wherein the at least one processor is further caused to output the set authentication information to an audio output unit.

12. The image processing apparatus according to claim 1, wherein the at least one processor is further caused to notify an administrator after the set authentication information is outputted.

13. An information processing terminal comprising:
at least one memory storing a program; and
at least one processor, that when executing the program, is causes to:
transmit authentication information input for login to an image processing apparatus,
determine whether authentication information set in the image processing apparatus is output by the image processing apparatus,
receive, in a case where the login is successful and the authentication information is output, input of new authentication information for updating, and
transmit the new authentication information to the image processing apparatus.

14. A method for processing information, the method comprising:
transmitting authentication information input for login to an image processing apparatus;
determining whether authentication information set in the image processing apparatus is output by the image processing apparatus;
receiving, in a case where the login is successful and the authentication information is output, input of new authentication information for updating; and
transmitting the new authentication information to the image processing apparatus.
